(19) United States
(12) Patent Application Publication
(10) Pub. No.: US 2008/0172882 A1
(43) Pub. Date: Jul. 24, 2008

(54) Shaving device

(76) Inventor: Noah M. Eger, Moon Twp., PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/656,798

(22) Filed: Jan. 23, 2007

(51) Int. Cl. B26B 21/40

(52) U.S. Cl. 30/49; 83/13

(57) ABSTRACT

Disclosed is a shaving device. The shaving device includes a blade element for contacting, cutting and removing hair from a skin surface. A retaining element engages the blade element, and a handle is in operational communication with the blade element for permitting a user to manipulate the blade element. The blade element is at least partially curved to contact and conform to a neck area of the user. A method of removing hair from a skin surface is also disclosed.

### BACKGROUND OF THE INVENTION

1. Field of the Invention

The present invention relates generally to a shaving device, such as a razor, and electric razor, a cutting utensil, a shaving device and the like and, in particular, to a shaving device having a blade configured to remove hair from a specified portion of the user's skin surface, e.g., the rear skin surface of the user's neck area.

2. Description of Related Art

According to the prior art, there are many different shaving devices and implements available for removing hair from various skin surfaces of a user. For example, there are presently available a variety of devices for removing hair from the user's facial area, e.g., a razor, a straight razor, an electronic razor, etc. In operation, such devices and implements are manipulated about a user's facial skin surface to remove the hair growing therefrom.

One drawback to such devices and implements is the nature of the cutting surface of the blade. Specifically, and according to the prior art, in most instances, the cutting surface of the blade implement is linear or flat. Such a flat surface is difficult to manipulate into the proper position for not only the facial surface, but, especially, the other areas on the body that require hair removal. Therefore, various blade moving mechanisms have been developed that allow the cutting surface to move as the user moves the shaving device around the skin surface. However, such shaving devices are expensive and/or require a complex mechanical mechanism to effectively move the blade over the cutting surface of the skin.

In addition, and due to the bulbous or rounded nature of the user's skin, various shaving devices have been developed that include a curved cutting edge or surface. For example, see U.S. Pat. No. 5,199,173 to Hegemann et al. and U.S. Pat. No. 5,182,858 to Chen, both of which disclose a curved cutting edge that is effective for a rounded surface of the skin. However, both of the devices of the Hegemann and Chen patents are specifically designed for the chin and other facial areas of the user. This is evidenced by the handles of these devices, which both are a projecting, linear structure graspable and useable by a user for the chin and front facial areas.

According, there is a need in the art for a shaving device or implement that can be used in connection with other areas of the user's body. In addition, there is considerable room in the art for improvements in the depilatory practice.

### SUMMARY OF THE INVENTION

It is one object of the present invention to provide a shaving device that overcomes the drawbacks and deficiencies of the prior art. It is another object of the present invention to provide a shaving device that is useful for contouring to the skin surface of the user. It is a further object of the present invention to provide a shaving device that can be manipulated for removing hair at a rear skin surface of a user's neck area. It is a still further object of the present invention to provide a user-adjustable shaving device that is adjustable according to the contour of the surface of the user.

Accordingly, the present invention is directed to a shaving device. The shaving device includes a blade element for contacting, cutting and removing hair from a skin surface. A retaining element engages the blade element, and a handle is in operational communication with the blade element for permitting a user to manipulate the blade element. The blade element is at least partially curved to contact and conform to a neck area of the user.

The present invention is further directed to a method of removing hair from a skin surface. The method includes the steps of: providing a blade element configured to contact, cut and remove hair follicles from a skin surface; a retaining element for engaging the blade element; and a handle in operational communication with the blade element and configured to permit a user to manipulate the blade element, wherein the blade element is at least partially curved to contact and conform to a neck area of the user; contacting a cutting edge of the blade element with the skin surface of a user; and moving the device over at least a portion of the skin surface, thereby removing at least a portion of the hair from the skin surface.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of a shaving device according to the principles of the present invention;

FIG. 2 is a plan view of one embodiment of a shaving device according to the principles of the present invention;

FIG. 3 is a plan view of another embodiment of a shaving device according to the principles of the present invention;

FIG. 4 is an edge view of a further embodiment of a shaving device according to the principles of the present invention;

FIG. 5 is an edge view of a still further embodiment of a shaving device according to the principles of the present invention;

FIG. 6 is an edge view of another embodiment of a shaving device according to the principles of the present invention;

FIG. 7 is a schematic view of a further embodiment of a shaving device according to the principles of the present invention; and

FIG. 8 is a schematic view of a still further embodiment of a shaving device according to the principles of the present invention.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

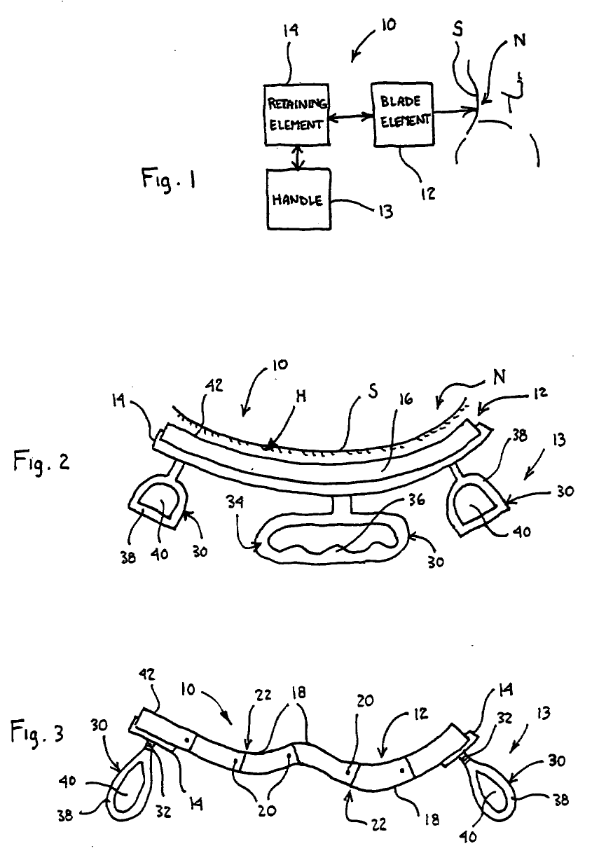

The present invention is directed to a shaving device 10, as illustrated in schematic form in FIG. 1 and in various embodiments in FIGS. 2-8. While the device 10 is particularly useful in connection with the skin surface S of a user's neck N, it is equally useful in connection with any skin surface S that is rounded or has other contours. For example, the skin surface S may be the user's legs, arms, chest, etc. In general, the present invention provides a device 10 that effectively removes hair H from the user's skin surface S, when the skin surface S has varying contours.

As show in schematic form in FIG. 1, the shaving device 10 includes a blade element 12 configured to contact, cut and remove hair H from the user's skin surface S, e.g., the user's neck N area. In addition, the device 10 includes a retaining element 14 for use in engaging the blade element 12. A handle 13 is in operational communication with the blade element 12, such as via the retaining element 14, and therefore configured to permit the user to manipulate the blade element 12. As is known in the art, when the blade element 12 is contacted with the skin surface S, the hair H thereon is removed.

As best seen in FIGS. 2 and 3, the blade element 12 of the present invention is at least partially curved to contact and conform to a contoured skin surface S of the user. As seen in FIG. 2, the blade element 12 is shaped (or curved) such that it can be comfortably and effectively urged against the user's skin surface S. As discussed above, the presently-invented shaving device 10 is particularly useful for removing the hair H from the skin surface S of the user's neck N.

In one preferred embodiment, the blade element includes a curvature that is manipulatable, changeable, modifiable, user-selectable, conformable, etc. As illustrated in FIG. 3, the blade element 12 (and in some embodiments the retaining element 14) can be user-adjustable to conform to the exact contour of the skin surface S. As all users will have a slightly different skin surface S contour or curvature, the user may, upon first use, adjust the curvature of the blade element 12 to match the contour of the skin surface S.

It is envisioned that the blade element 12 may be a single contiguous blade 16 (FIG. 2) or formed from a plurality of blade segments 18. When using the blade segments 18, the individual blade segments 18 may be rigid, but these segments 18 are connected to each other in a moveable manner. For example, the individual blade segments 18 may be connected together via pins 20 attaching one end portion 22 of a first blade segment 18 to the end portion 22 of an adjacent blade segment 18. It is also envisioned that the blade element 12 is manufactured from a material that is bendable, manipulable, flexible, rigid or any combination thereof. Accordingly, the blade element 12 is manufactured from a metal, a semi-metal, a synthetic material, a polymer, a plastic or any combination thereof.

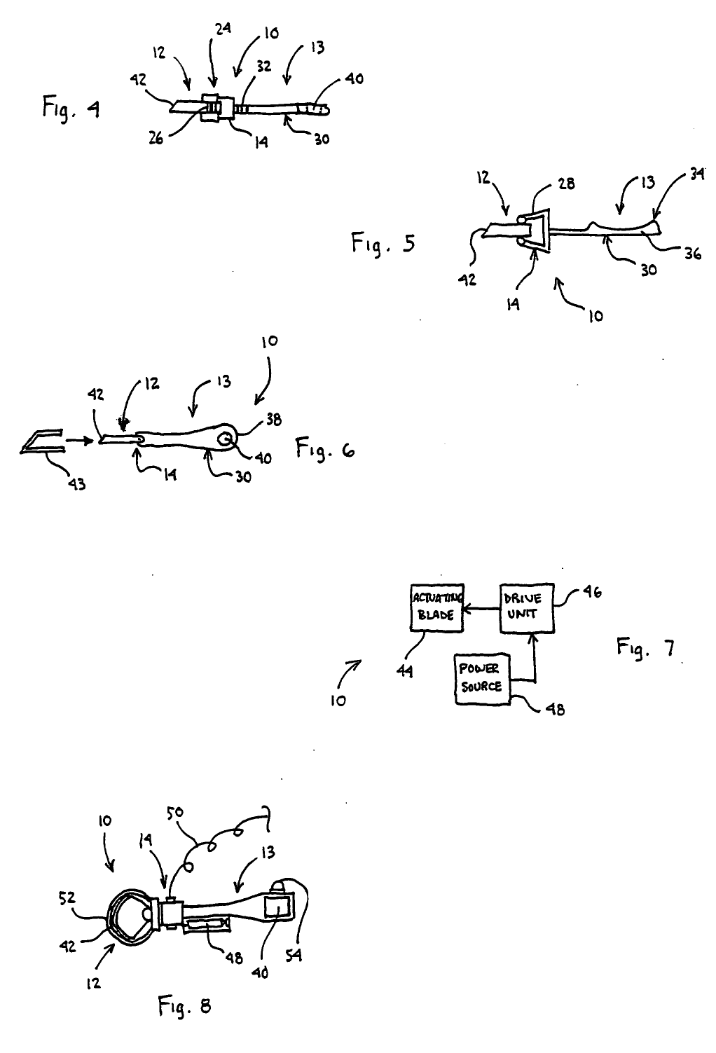

As seen in FIGS. 4-6, the blade element 12 may be removably attachable to the retaining element 14. For example, the retaining element 14 may include a snap mechanism 24 that is arranged to allow the user to remove the retaining element 14 to the blade element 12 through a snap orifice 26 extending through the blade element 12. See FIG. 4. In addition, as illustrated in FIG. 5, the retaining element 14 may include a clip 28 configured to removably engage the blade element 12 in a fixed position relative to the handle 13. Since the blade element 12 is removable from the retaining element 14, the blade element 12 can be replaced by the user when it becomes dull, or otherwise requires maintenance, repair or replacement.

The handle 13 may take many forms and configurations to allow the user to effectively grasp the handle and move the blade element 12 about the skin surface S of the user. The handle 13 includes a projection portion 30 that allows the user to hold and move the shaving device 10. Still further, as seen in FIG. 4, this projection portion 30 may be moveable, adjustable or capable of manipulation through the use of a flexion portion 32. In this manner, the user can easily manipulate the handle 13 to find the most comfortable shaving process, and the handle 13 may also then move as the user is engaging in the shaving process.

FIG. 5 illustrates a handle 13 with a grasping portion 34 configured to permit the user to comfortably and effectively grasp the handle 13 with the user's hands. This grasping portion 34 may be in the form of a grip portion 36, such as the grip portion 36 shown in FIG. 5. Also, as seen in FIGS. 2-4, the handle 13 is in the form of a loop 38 or other similar structure having a grasping orifice 40 that the user may position his hands or fingers through. In one preferred and non-limiting embodiment, the handle 13 includes two loops 38 positioned on either end of the blade element 12. In operation, the user grasps each loop 38 with his hands (fingers) and places a cutting edge 42 of the blade element 12 against his or her skin surface S. Next, the user engages in the shaving process by moving the device 10 about the skin surface S. This two-loop arrangement is particularly useful when removing the hair H from the user's neck N.

As discussed above, the blade element 12 may be removable from the retaining element 14, which allows the user to change the blade element 12, i.e., obtain a new, sharp cutting edge 42. In addition, the handle 13 may be removable from the retaining element 14 and/or blade element 12, which allows the user to use interchangeable handles 13 for a variety of different shaving needs. However, it is also envisioned that the components of the shaving device 10 are attached, fixed, removably attached, integral, etc.

The shaving device 10 may also include a guard portion 43, which is removably positionable over the blade element 12. As seen in FIG. 6, the guard portion 43 can be positioned over and removed from the blade element 12 for storage and protection purposes. In particular, the cutting edge 42 of the blade element 12 is protected using this guard portion 43.

In another preferred and non-limiting embodiment, and as illustrated in schematic form in FIG. 7, the blade element 12 of the shaving device 10 may include an actuated cutting edge 44 that moves in an operation to cut and/or remove hair H from the skin surface S. Accordingly, the blade element 12 is in communication with a drive unit 46 configured to mechanically drive the blade element 12 (and cutting edge 44) in the operation. The drive unit 46 is in electrical communication with a power source 48. For example, the power source 48 may be a battery 48, an electrical cord 50 or any combination thereof.

As best seen in FIG. 8, the actuated cutting edge 44 is positioned in a housing 52, and the housing 52 is conformed with or conformable to the user's skin surface S. For example, as is known in the art of electronic shaving devices, the housing 52 is formed together with the cutting edge 44 to remove the hair H, but to also protect the skin surface S from cuts and nicks. In this embodiment, the blade element 12 is in direct or indirect communication with an actuation switch 54 configured to initiate or cease the blade element 12 operation.

The present invention is further directed to a method of removing hair H from a skin surface S. This method includes the steps of: (a) providing a blade element 12 for contacting, cutting and/or removing hair from the skin surface S; a retaining element 14 for engaging the blade element 12; and a handle 13 in operational communication with the blade element 12 for permitting a user to manipulate the blade element 12, where the blade element 12 is at least partially curved to contact and conform to the skin surface of the user; (b) contacting a cutting edge 42 of the blade element 12 with the skin surface S of a user; and (c) moving the device 10 over at least a portion of the skin surface S, thereby removing at least a portion of the hair H from the skin surface S. Again, and in one preferred embodiment, the skin surface S is a rear portion of a user's neck N area.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A shaving device, comprising:
a blade element configured to contact, cut and remove hair from a skin surface;
a retaining element for engaging the blade element; and
a handle in operational communication with the blade element and configured to permit a user to manipulate the blade element,
wherein the blade element is at least partially curved to contact and substantially conform to a contoured skin surface of the user.

2. The device of claim 1, wherein the blade element includes a curvature that is manipulatable, changeable, modifiable, user-selectable, conformable or any combination thereof.

3. The device of claim 2, wherein the blade element is conformable by the user to a surface of the user's neck.

4. The device of claim 1, wherein the blade element is removably attachable to the retaining element.

5. The device of claim 1, wherein the retaining element includes at least one clip configured to removably engage the blade element in a fixed position relative to the handle.

6. The device of claim 1, wherein the handle comprises at least one grasping portion configured to permit a user to grasp the handle with the user's hands.

7. The device of claim 6, wherein the handle comprises at least two loop elements attached to or integral with the retaining element.

8. The device of claim 1, wherein the handle comprises at least one projection portion sized and shaped so as to be grasped by a user.

9. The device of claim 1, wherein the handle comprises a grip portion positioned on or around the handle and configured for contact with a hand of a user.

10. The device of claim 1, wherein the handle and the retaining element is at least one of attached, fixed, removably attached, integral or any combination thereof.

11. The device of claim 1, further comprising a guard portion removably positionable on the blade element.

12. The device of claim 1, wherein the blade element comprises a cutting edge configured to contact and cut hair from a user's skin surface.

13. The device of claim 1, wherein the blade element comprises an actuating cutting edge configured to move in an operation to cut and/or remove hair.

14. The device of claim 13, wherein the blade element is in communication with a drive unit configured to mechanically drive the blade element in the operation.

15. The device of claim 14, wherein the drive unit is in operational communication with a battery, an electrical cord or any combination thereof.

16. The device of claim 13, wherein the blade element is in direct or indirect communication with an actuation switch configured to initiate or cease the blade element operation.

17. The device of claim 1, wherein the blade element is manufactured from a material that is bendable, manipulable, flexible, rigid or any combination thereof.

18. The device of claim 1, wherein the blade element is manufactured from a metal, a semi-metal, a synthetic material, a polymer, a plastic or any combination thereof.

19. A method of removing hair from a skin surface, the method comprising the steps of:
providing a blade element configured to contact, cut and/or remove hair from the skin surface; a retaining element for engaging the blade element; and a handle in operational communication with the blade element and configured to permit a user to manipulate the blade element, wherein the blade element is at least partially curved to contact and conform to the skin surface of the user;
contacting a cutting edge of the blade element with the skin surface of a user; and
moving the device over at least a portion of the skin surface, thereby removing at least a portion of the hair from the skin surface.

20. The method of claim 19, wherein the skin surface is a rear portion of a user's neck area.
